(19) United States
(12) Patent Application Publication
(10) Pub. No.: US 2025/0265120 A1
(43) Pub. Date: Aug. 21, 2025

(54) ADAPTIVE KSWAPD TUNING

(71) Applicant: Microsoft Technology Licensing, LLC, Redmond, WA (US)

(72) Inventor: Ishan PANDITA, Hyderabad (IN)

(21) Appl. No.: 18/581,125

(22) Filed: Feb. 19, 2024

(51) Int. Cl. G06F 9/50; G06N 3/044; G06N 3/084

(52) U.S. Cl. CPC G06F 9/5016; G06N 3/044; G06N 3/084

(57) ABSTRACT

Systems and methods are directed to adaptively tuning kswapd based on neural network functions trained by a server. The server trains, using a neural network, a first function and a second function, whereby the first function is used to predict a reclaim size for reclaiming memory on a user device and the second function is used to adjust a reclaim amount for the memory. In response to completion of the training, the server offloads weights of the first function and the second function to the user device. The weights cause an adjustment to the reclaim size and reclaim amount associated with kswapd at the user device. The user device then predicts the reclaim size based on the first function and adjusts the reclaim amount based on the second function. The user device then reclaims memory based on the predicted reclaim size and adjusted reclaim amount when kswapd is woken.

### TECHNICAL FIELD

The subject matter disclosed herein generally relates to memory management. Specifically, the present disclosure addresses systems and methods to reclaim pages using adaptive kswapd tuning based on neural network functions trained by a server.

### BACKGROUND

Kwaspd is a kernel daemon responsible for freeing pages in devices. Usually, kwaspd is asleep. If an amount of free memory runs belows a low watermark, kwaspd is woken up and tries to reclaim pages until a high watermark is reached. When kwaspd is not able to free pages in time, the freeing of pages becomes synchronous (also referred to as direct reclaim). At this stage Android devices become sluggish because Android devices have inherited a Linux memory management model suitable for workstation workloads.

### BRIEF DESCRIPTION OF THE DRAWINGS

Some embodiments are illustrated by way of example and not limitation in the figures of the accompanying drawings.

FIG. 1 is a diagram illustrating a network environment suitable for reclaiming pages using adaptive kswapd tuning, in accordance with example implementations.

FIG. 2 is a block diagram illustrating an example software architecture, which may be used in conjunction with an Android device, in accordance with example implementations.

FIG. 3 is a diagram showing example components within a memory management system at a server, in accordance with example implementations.

FIG. 4 is a flowchart illustrating operations of a method for adaptively tuning kswapd at the Android device, according to some example implementations.

FIG. 5 is a flowchart illustrating operations of a method for adaptively tuning kswapd at the server, according to some example implementations.

FIG. 6 is a block diagram illustrating components of a machine, according to some example implementations, able to read instructions from a machine-storage medium and perform any one or more of the methodologies discussed herein.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Example embodiments are directed to memory management and reclaiming pages using adaptive kswapd tuning. Conventionally, Android devices inherit a Linux memory management model. The Linux memory management model is designed for different workloads (e.g., workstation workloads) then, for example, on an Android smartphone or other Android mobile devices. During system startup of the Android device, a kernal thread kswapd is started. Kswapd is a kernal swap daemon that is responsible for reclaiming pages when memory is running low. Whenever a low watermark (also referred to as “pages_low” or “watermark_low”) gets breached, kswapd is woken up by a physical page allocator. Kswapd attempts to free pages until a high watermark (also referred to as “watermark_high”) is reached. This is done asynchronously. As such, device performance is not affected since new page allocations are also occurring while kswapd is freeing pages.

If page deallocation or reclaiming is not able to free enough pages, then a minimum (min) watermark may also get breached. This means that new page allocations are occurring faster than freeing of pages. Under this extreme memory pressure, one or more other components of the Android device (e.g., a physical page allocator) can synchronously perform the same tasks as kswapd. As a result, the asynchronous process will turn into a synchronous process where new page allocations stop and only freeing of pages occur. This synchronous process is also referred to herein as a “direct reclaim.” At this stage, the Android device becomes sluggish and heats up.

To address the above disadvantages, example implementations adaptively tune parameters of kswapd. Currently, when kswapd is woken up, it tries to free pages until pages_high watermark (also referred to herein as “high watermark”) is reached. Pages_high watermark is conventionally a constant value. However, example implementations convert pages_high watermark into an adaptive and dynamic value or parameter. If a system knows heavy workload is coming, the value of the high watermark can be increased such that more pages will be freed and sufficient pages will be available. As a result, a low memory situation does not occur.

Another parameter that is adaptively tuned by example implementations is a reclaim size of zone or order of allocation. Example implementations reclaim pages as two to a power. If the reclaim size is too high (e.g., the order of freeing is too high), too many pages are freed at one time. If this happens, then thrashing may occur. However, if the reclaim size is too low, then freeing will not be performed in enough time and a direct reclaim process may be triggered. Thus, example implementations also tune the reclaim size (or order of allocation) based on expected workload.

As a result, example implementations provides a technical solution to the technical problem of reclaiming pages on an Android device. Example implementations model reclaim size and reclaim amount as deep recurrent neural network-based function approximators. These functions are trained offline in a server (e.g., in a cloud service). Post completion of training, weights (e.g., formulas for the functions) are offloaded to the Android device during over-the-air (OTA) updates. The reclaim size and reclaim amount functions can be trained using backpropagation through time algorithms to reduce an amount of direct reclaims triggered in a same workload. By minimizing direct reclaim processes, example implementations minimize events where the Android device becomes sluggish and thus provides technical advantages of improved power consumption, improved device performance, and better user impact (e.g., by improving/avoiding sluggishness or slowness of the Android device).

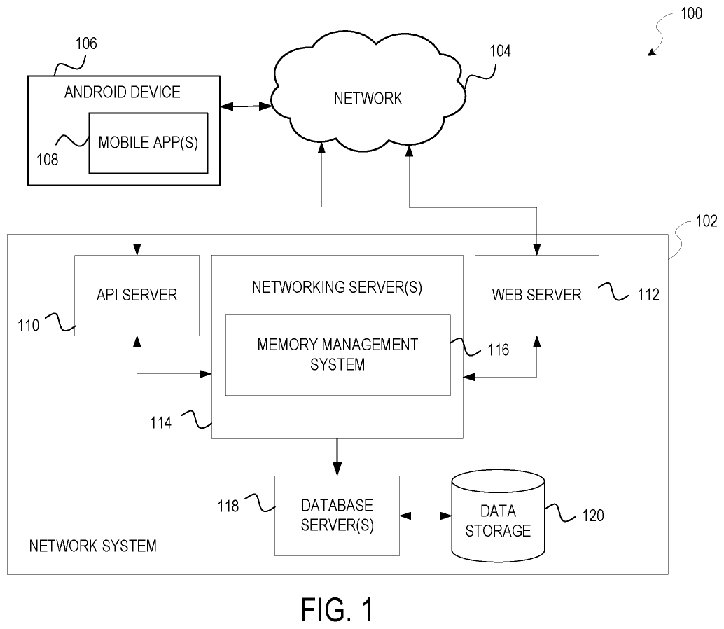

FIG. 1 is a diagram illustrating a network environment suitable for reclaiming pages using adaptive kswapd tuning, in accordance with example implementations. A network system 102 provides server-side functionality via a communication network 104 (e.g., the Internet, wireless network, cellular network, or a Wide Area Network (WAN)) to an Android device 106. The network environment 100 is configured to adaptively tune kswapd parameters, as will be discussed in more detail below.

The Android device 106 may comprise, but is not limited to, a smartphone, tablet, e-book reader, or any other type of mobile device that has an Android operating system. In various cases, the Android device 106 is a device associated with a user of the network system 102. The Android device 106 comprises one or more mobile applications 108 that communicate with the network system 102 for added functionality. In one embodiment, the mobile application 108 comprises a communication component that exchanges data with the network system 102. For example, the mobile application 108 may be a local version of an application or component of the network system 102. Alternatively, the mobile application 108 exchanges data with one or more components/applications at the network system 102. The mobile application 108 and/or updates to an operating system of the Android device 106 may be provided by the network system 102 and/or downloaded to the Android device 106.

In some cases, the Android device 106 interfaces with the network system 102 via a connection with the network 104. Depending on the form of the Android device 106, any of a variety of types of connections and networks 104 may be used. For example, the connection may be Code Division Multiple Access (CDMA) connection, a Global System for Mobile communications (GSM) connection, or another type of cellular connection. Such a connection may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks, 5G networks). When such technology is employed, the network 104 includes a cellular network that has a plurality of cell sites of overlapping geographic coverage, interconnected by cellular telephone exchanges. These cellular telephone exchanges are coupled to a network backbone (e.g., the public switched telephone network (PSTN), a packet-switched data network, or other types of networks.

In another example, the connection to the network 104 is a Wireless Fidelity (e.g., Wi-Fi, IEEE 802.11x type) connection, a Worldwide Interoperability for Microwave Access (WiMAX) connection, or another type of wireless data connection. In such an example, the network 104 includes one or more wireless access points coupled to a local area network (LAN), a wide area network (WAN), the Internet, or another packet-switched data network. In yet another example, the connection to the network 104 is a wired connection (e.g., an Ethernet link) and the network 104 is a LAN, a WAN, the Internet, or another packet-switched data network. Accordingly, a variety of different configurations are expressly contemplated.

Turning specifically to the network system 102, an application programing interface (API) server 110 and a web server 112 are coupled to and provide programmatic and web interfaces respectively to one or more networking servers 114. The networking server(s) 114 host various systems including a memory management system 116, which comprises a plurality of components and which can be embodied as hardware, software, firmware, or any combination thereof. The networking server(s) 114 are, in turn, coupled to one or more database servers 118 that facilitate access to one or more storage repositories or data storage 120. The data storage 120 is a storage device storing, for example, user accounts including user profiles of users of the network system 102.

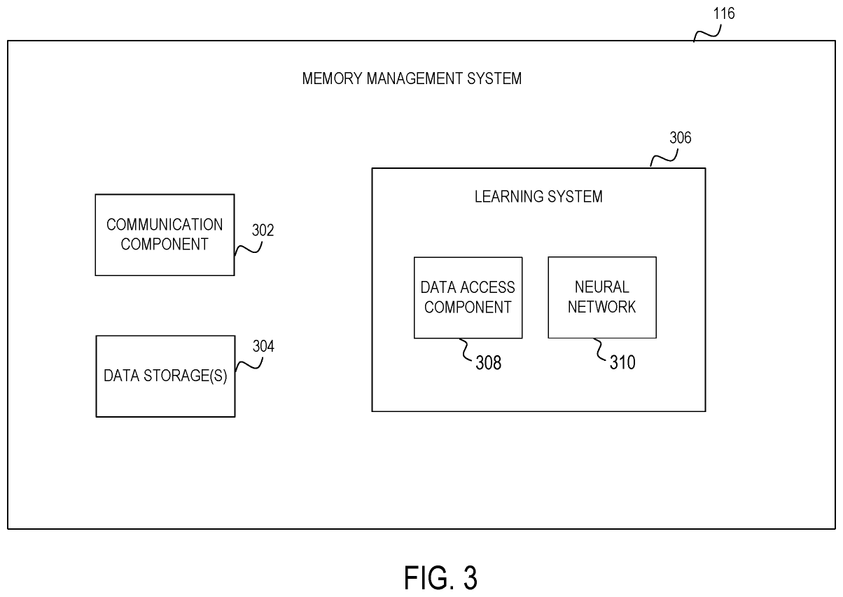

The memory management system 116 is configured to adaptively tune kswapd, and more particularly, tune reclaim size of zone and reclaim amount of zone parameters. The memory management system 116 will be discussed in more detail in connection with FIG. 3 below.

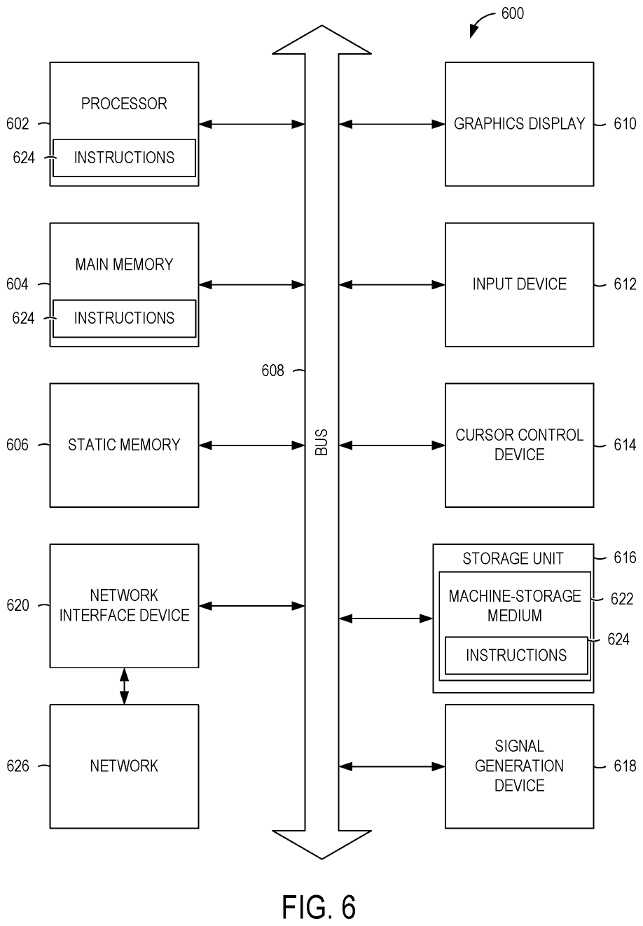

In example implementations, any of the systems, devices, or networks (collectively referred to as “components”) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system, device, or machine. For example, a special-purpose computer system able to implement any one or more of the methodologies described herein is discussed below with respect to FIG. 6, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other computers that lack the structures discussed herein or are otherwise unable to perform the functions discussed herein. Accordingly, a special-purpose machine configured according to the systems and methods discussed herein provides an improvement to the technology of similar machines.

Moreover, any of the components illustrated in FIG. 1 or their functions may be combined, or the functions described herein for any single component may be subdivided among multiple components. Additionally, any number of Android devices 106 may be embodied within the network environment 100. While only a single network system 102 is shown, alternative implementations contemplate having more than one network system 102 (e.g., each localized to a particular region) to perform the operations discussed herein.

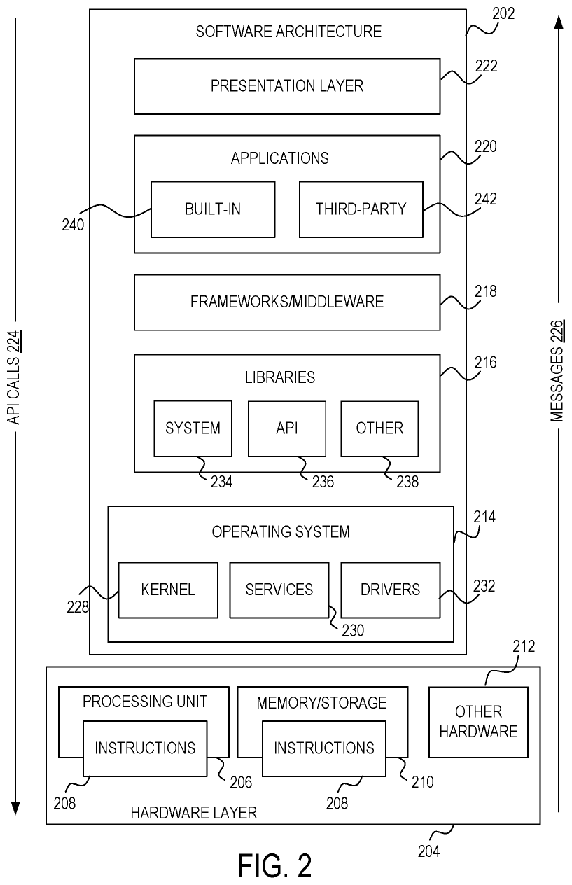

FIG. 2 is a block diagram illustrating an example software architecture 202, which may be used in conjunction with the Android device 106. FIG. 2 is a non-limiting example of a software architecture 202 and it will be appreciated that many other architectures may be implemented to facilitate the functionality described herein. The software architecture 202 may execute on hardware such as machine 600 of FIG. 6. A representative hardware layer 204 is illustrated and can represent, for example, the machine 600 of FIG. 6. The representative hardware layer 204 includes a processing unit 206 having associated executable instructions 208. Executable instructions 208 represent the executable instructions of the software architecture 202, including implementation of the methods, components, and so forth described herein. The hardware layer 204 also includes memory and/or storage components 210, which also have executable instructions 208. The hardware layer 204 may also comprise other hardware 212.

In the example architecture of FIG. 2, the software architecture 202 may be conceptualized as a stack of layers where each layer provides particular functionality. For example, the software architecture 202 may include layers such as an operating system 214, libraries 216, frameworks/middleware 218, applications 220, and a presentation layer 222. Operationally, the applications 220 and/or other components within the layers may invoke Application Programming Interface (API) calls 224 through the software stack and receive a response such as messages 226 in response to the API calls 224. The layers illustrated are representative in nature and not all software architectures have all layers. For example, some mobile or special purpose operating systems may not provide a frameworks/middleware 218, while others may provide such a layer. Other software architectures may include additional or different layers.

The operating system 214 manages hardware resources and provide common services. The operating system 214 may include, for example, a kernel 228, services 230, and drivers 232. The services 230 may provide other common services for the other software layers. The drivers 232 are responsible for controlling or interfacing with the underlying hardware. For instance, the drivers 232 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The kernel 228 may act as an abstraction layer between the hardware and the other software layers. In example implementations, the kernel 228 is responsible for memory management, processor management (e.g., scheduling), component management, networking, security settings, and so on. As previously discussed, the kernel 228 is a Linux kernel. In some cases, the kernel 228 detects trends for page allocations (e.g., will know if new page allocations are happening very fast and the trend is going up or vice-versa). A memory management subsystem in the kernel 228 has a function which detects how many pages are being allocated. Example implementations place a check in that function that checks how many page allocations are happening in how much time. For example, a check can be performed every five seconds to see if there is an increase (e.g., trend increasing) or decrease (e.g., trend decreasing). Thus, trend is based on current processes deployed on the Android device 106. This trend information is used by the Android device 106 to determine the reclaim size and reclaim amount as will be discussed further herein.

The libraries 216 provide a common infrastructure that is used by the applications 220 and/or other components and/or layers. The libraries 216 provide functionality that allows other software components to perform tasks in an easier fashion than to interface directly with the underlying operating system 214 functionality (e.g., kernel 228, services 230, and/or drivers 232). The libraries 216 may include system libraries 234 (e.g., C standard library) that may provide functions such as memory allocation functions, string manipulation functions, mathematical functions, and the like. In addition, the libraries 216 may include API libraries 236 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 216 may also include a wide variety of other libraries 238 to provide many other APIs to the applications 220 and other software components/modules.

The frameworks/middleware 218 (also sometimes referred to as middleware) provide a higher-level common infrastructure that may be used by the applications 220 and/or other software components/modules. For example, the frameworks/middleware 218 may provide various graphical user interface (GUI) functions, high-level resource management, high-level location services, and so forth. The frameworks/middleware 218 may provide a broad spectrum of other APIs that may be used by the applications 220 and/or other software components/modules, some of which may be specific to a particular operating system 214 or platform.

The applications 220 include built-in applications 240 and/or third-party applications 242. Examples of representative built-in applications 240 may include, but are not limited to, a contacts application, a browser application, a book reader application, a location application, a media application, a messaging application, and/or a game application. Third-party applications 242 may include an application developed using an Android software development kit (SDK) by an entity other than the vendor of the particular platform, and may be mobile software running on a mobile operating system such as an Android or other mobile operating systems. The third-party applications 242 may invoke the API calls 224 provided by the mobile operating system (such as operating system 214) to facilitate functionality described herein.

The applications 220 may use built-in operating system functions (e.g., kernel 228, services 230, and/or drivers 232), libraries 216, and frameworks/middleware 218 to create UIs to interact with users of the system. Alternatively, or additionally, in some systems, interactions with a user may occur through a presentation layer, such as presentation layer 222. In these systems, the application/component “logic” can be separated from the aspects of the application/component that interact with a user.

FIG. 3 is a diagram showing example components within the memory management system 116, in accordance with example implementations. The memory management system 116 adaptively tunes kswapd and more particularly, tunes the reclaim size of zone and reclaim amount of zone. These two parameters are tuned as functions whereby a first function (Func1) is a reclaim size of the zone and second function (Func2) is a reclaim amount of zone. To enable these operations, the memory management system 116 comprises a communication component 302, data storages 304, and a learning system 306, all communicatively couple to each other. Other components not shown may be embodied within the network system 102 but not utilized for example implementations.

The communication component 302 is configured to exchange information with the Android device 106. For example, the communication component 302 can receive workload sequences and status information from the Android devices 106. The workload sequences can indicate a sequence of operations performed on the Android device 106. In some cases, the workload sequences or the status information include indications of whether direct reclaims were triggered at the Android device 106. For example, the workload sequence can indicate at timestamp T1, the state is S1, while at timestamp T2, the state is S2, and so forth. In example implementations, the state may indicate a trend based on current processes deployed at the corresponding timestamp.

The communication component 302 also provides the weights of Func1 and Func2 back to the Android device 106 after training by the learning system 306. In example implementations, weights for Func1 and Func2 are offloaded to the Android device 106. The weights may be the formula for Func1 and Func2, themselves. The offloading may occur with a next auto-update. In these cases, a neural network may also be embodied on the Android device 106, for example, separate from the memory management subsystem of the kernel 228.

In some cases, the data storage 304 stores the workload sequences and status information received from the Android device 106 prior to training by the learning system 306. In other cases, the workload sequences and status information is received by the communication component 302 and provided directly to the learning system 306.

The learning system 306 trains Func1 and Func2 offline on the server (e.g., memory management system 116). The learning system 306 comprises a data access component 308 and a neural network 310. The data access component 308 accesses the data needed to train Func1 and Func2. Accordingly, the data access component 308 may access the data from the data storage 304 (or as it is received from the Android device 106) and pass the data onto the neural network 310.

In example implementations, the neural network 310 is a recurrent neural network (RNN). As discussed, Func1 is a reclaim size of the zone and Func2 is a reclaim amount of zone. The neural network trains using backpropagation through time algorithm. Backpropagation through time algorithm is a gradient-based technique for training certain types of recurrent neural networks. For instance, at various times, the high watermark was supposed to be certain values and the same neural network 310 will be used to train the high watermark at all stages. By all stages, one neural network 310 is fixed for all values given it a previous value and trend and incorporates everything into account and gives a next value at all times.

Typically, backpropagation is a training algorithm used for training neural networks. The backpropagation training algorithm aims to modify weights of a neural network to minimize the error of network results compared to some expected output in response to corresponding inputs. Example implementations takes time factor into consideration. Thus, at timestamp T1, the neural network 310 is at state S1 and at timestamp T2, the state is S2 and both are taken into account when calculating error. Additionally, by using RNN, a training sequence (e.g., workload sequence) can be taken into account. Since the use of an Android device (e.g., smartphone) changes over time (e.g., user can open multiple applications over time, send texts, and make a call serially or in parallel), training sequences over time are used for training. These training sequences can indicate trends at various times (or timestamps).

Initially, the neural network 310 trains Func1 and Func2 using backpropagation through time algorithm. Next, there is a feedback mechanism. The fewer the amount of direct reclaims triggered in a same workload, the better the parameters and Func1 and Func2 are better approximators. As previously discussed, direct reclaim is the process where new page allocation is stopped and only freeing is performed. The fewer the number of times this occurs, the better will be the parameters. The neural network 310 can check how many direct reclaims occurred (e.g., if it is greater than zero in a given time frame), in order to minimize that value. That errors can be sent back in time. Thus, after passing backpropagation through time algorithm, Func1 and Func2 are tuned to lower the number of direct reclaims.

The neural network 310 also considers a number of training instances. The number of training instances is a number of total workload sequences which have been taken into account. Suppose the neural network 310 takes N training sequences or number of workloads into account. Then using the backpropagation through time algorithm, the neural network 310 is able to find Func1 and Func2 which will minimize the number of direct reclaims over all N number of workloads. Thus, the neural network 310 is finding parameters which will minimize the number of direct reclaims over all the workload sequences, not just one.

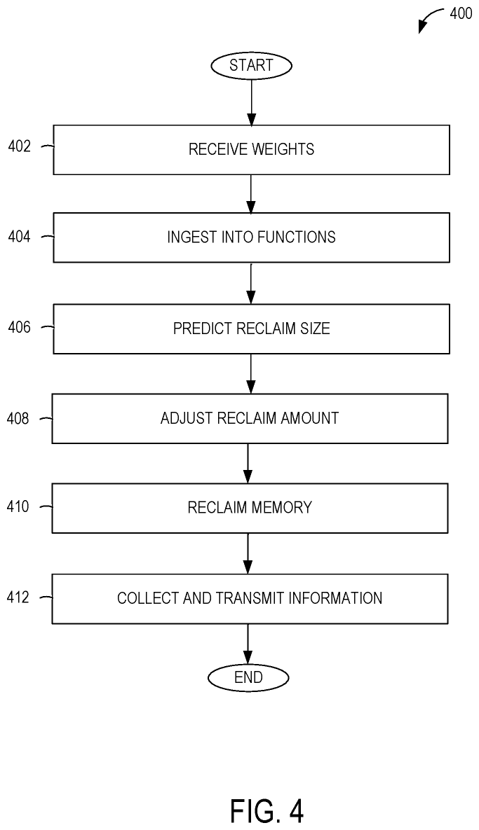

FIG. 4 is a flowchart illustrating operations of a method for adaptively tuning kswapd at the Android device 106, according to some example implementations. Operations in the method 400 may be performed by the Android device 106 in the network environment 100 described above with respect to FIG. 1. Accordingly, the method 400 is described by way of example with reference to this component in the network environment 100. However, it shall be appreciated that at least some of the operations of the method 400 may be deployed on various other hardware configurations or be performed by similar components residing elsewhere in the network environment 100. Therefore, the method 400 is not intended to be limited to these components.

In operation 402, the Android device 106 receives current weights for Func1 and Func2 from a cloud service or server (e.g., the memory management system 116). The server trains a reclaim size function (Func1) and reclaim amount function (Func2) and provides weights of Func1 and Func2 to the Android device 106. The weights may be offloaded to the Android device 106 during an over-the-art update. In example implementations, the weights are Func1 and Func2, themselves. That is the weight is the formula for Func1 and Func2. The goal is to tune Func1 and Func2 such that sufficient pages will be freed in time so that when new pages are requested, sufficient pages are already freed.

In 404, the Android device 106 ingests the weights directly into the reclaim size parameter and reclaim amount parameter. Thus, the reclaim size for kswapd is a function of the (previously) predicted reclaim size and current trend. The reclaim amount for kswapd is a function of the (previously) predicted watermark_high, watermark_low, and the current trend. The (previously) predicted reclaim amount provides the watermark_high.

In operation 406, the Android device 106 uses Func1 to predict the reclaim size to use. The reclaim size, Func1, is a function of previous predicted reclaim size and the trend (e.g., how the user is using the Android device 106). The trend will indicate if workload will be heavy or light and thus, how many pages may be needed. As discussed, example implementations free pages in two to a power of x pages (e.g., 2¹, 2², 2³, 2^{x}) where x is the reclaim size of zone. This is the number of pages that are reclaimed at one time. Freeing too quickly may cause thrashing, but freeing too slow may cause direct reclaim to occur.

In operation 408, the Android device 106 uses Func2 to adjust the reclaim amount. The reclaim amount, Func2 is a function of high watermark, low watermark, and trend. Here, the high watermark is the previous value of the reclaim amount, while the low watermark is constant. For example, if previous high watermark is 5, it can either increase or decrease from that based on the trend. For example, if heavy workload will be occurring, the value of a high watermark is increased based on the training and is tuned to a high value to free more pages. In operation 410, the Android device 106 reclaims memory when the

watermark_low is transgressed and kswapd is woken up. The reclaiming occurs using the reclaim size determined in operation 408 and the reclaim amount determined in operation 410. Thus, the Android device 106 is reclaiming pages based on weights of the functions from a previous training.

In operation 412, the Android device 106 collects information and sends it back to the server for retraining. The information can include new workload sequences and status information. The new workload sequences can indicate new sequences of operations performed on the Android device 106 and trends based on current processes deployed at the Android device 106 at various timestamps, while the status information can include indications of whether direct reclaims were triggered at the Android device 106.

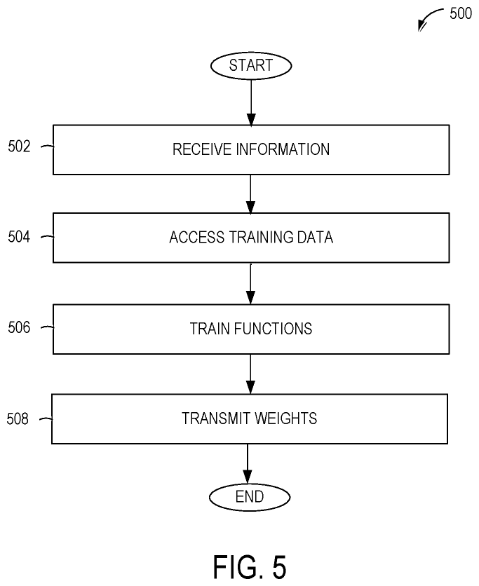

FIG. 5 is a flowchart illustrating operations of a method for adaptively tuning kswapd at a server, according to some example implementations. Operations in the method 500 may be performed by a server, and more specifically, the memory management system 116 of the network system 102 in the network environment 100 described above with respect to FIG. 1 and FIG. 3. Accordingly, the method 500 is described by way of example with reference to these components in the network system 102. However, it shall be appreciated that at least some of the operations of the method 500 may be deployed on various other hardware configurations or be performed by similar components residing elsewhere in the network environment 100. Therefore, the method 500 is not intended to be limited to these components.

In operation 502, the memory management system 116 (e.g., the communication component 302) receives the information from the Android device 106. The information can include workload sequences and status information. The information can be stored in the data storage 304 for later use or provided to (or accessed directly by) the learning system 306.

In operation 504, the learning system 306 (e.g., the data access component 308) accesses the training data. The training data can include the workload sequences and status information. In some cases, the training data can be accessed from the data storage 304. The learning system 306 also access the information received in operation 502.

In operation 506, the learning system 306 (e.g., the neural network) 310 trains (or retrains) Func1 and Func2. Example implementations use a recurrent neural network (RNN). RNN uses a backpropagation through time algorithm to train Func1 and Func2. After a pass of the backpropagation through time algorithm, Func1 and Func2 will be tuned for a lower number of direct reclaims. The fewer amount of direct reclaims triggered in the same workload, the better approximators Func1 and Func2 are. Assume the number of training instances (e.g., the number of total workload sequences) which have been taken into account is n. The learning system 306, using backpropagation through time, determines Func1 and Func2 by minimizing the number of direct reclaims over n number of workloads.

In operation 508, the memory management system 116 transmits weights of Func1 and Func2 to the Android device 106. After the training/retraining, the updated weights are transmitted to the Android device 106 to adaptively tune kswapd at the Android device 106. In some cases, the transmitting occurs during an over-the-air auto-update. Thus, with every auto-update, weights of the neural network can be updated.

While example implementations are discussed above using a RNN and

backpropagation through time algorithm, alternative implementations may use a different machine learning model. Furthermore, instead of using trend and the previous parameters (e.g., predicted reclaim size and predicted reclaim amount/watermark_high), other parameters can be used to tune kswapd. Finally, while example embodiments discuss the user device being an Android device 106, elements of example implementations may be used in other types of devices (e.g., non-Android devices) that utilize a Linux kernel.

FIG. 6 illustrates components of a machine 600, according to some example implementations, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 6 shows a diagrammatic representation of the machine 600 in the example form of a computer device (e.g., a computer) and within which instructions 624 (e.g., software, a program, an application, an applet, an app, or other executable code) for causing the machine 600 to perform any one or more of the methodologies discussed herein may be executed, in whole or in part.

For example, the instructions 624 may cause the machine 600 to execute the flow diagram of FIG. 4 and FIG. 5. In one implementation, the instructions 624 can transform the machine 600 into a particular machine (e.g., specially configured machine) programmed to carry out the described and illustrated functions in the manner described.

In alternative implementations, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624 (sequentially or otherwise) that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The processor 602 may contain microcircuits that are configurable, temporarily or permanently, by some or all of the instructions 624 such that the processor 602 is configurable to perform any one or more of the methodologies described herein, in whole or in part. For example, a set of one or more microcircuits of the processor 602 may be configurable to execute one or more modules (e.g., software modules) described herein.

The machine 600 may further include a graphics display 610 (e.g., a plasma display panel (PDP), a light emitting diode (LED) display, a liquid crystal display (LCD), a projector, or a cathode ray tube (CRT), or any other display capable of displaying graphics or video). The machine 600 may also include an input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a sound card, an amplifier, a speaker, a headphone jack, or any suitable combination thereof), and a network interface device 620.

The storage unit 616 includes a machine-storage medium 622 (e.g., a tangible machine-storage medium) on which is stored the instructions 624 (e.g., software) embodying any one or more of the methodologies or functions described herein. The instructions 624 may also reside, completely or at least partially, within the main memory 604, within the processor 602 (e.g., within the processor's cache memory), or both, before or during execution thereof by the machine 600. Accordingly, the main memory 604 and the processor 602 may be considered as machine-storage media (e.g., tangible and non-transitory machine-storage media). The instructions 624 may be transmitted or received over a network 626 via the network interface device 620.

In some example implementations, the machine 600 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the components described herein.

### Executable Instructions and Machine-Storage Medium

The various memories (e.g., 604, 606, and/or memory of the processor(s) 602) and/or storage unit 616 may store one or more sets of instructions and data structures (e.g., software) 624 embodying or utilized by any one or more of the methodologies or functions described herein. These instructions, when executed by processor(s) 602 cause various operations to implement the disclosed embodiments.

As used herein, the terms “machine-storage medium,” “device-storage medium,” “computer-storage medium” (referred to collectively as “machine-storage medium 622”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 622 include non-volatile memory, including by way of example semiconductor memory devices, for example, erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 622 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium,” and “device-readable medium” mean the same thing and may be used interchangeably in this disclosure. The terms are defined to include both machine-storage medium/media and signal medium/media. Thus, the terms include both storage devices/media and carrier waves/modulated data signals.

The instructions 624 may further be transmitted or received over a communications network 626 using a transmission medium via the network interface device 620 and utilizing any one of a number of well-known transfer protocols (e.g., HTTP). Examples of communication networks 626 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 624 for execution by the machine 600, and includes digital or analog communications signals or other intangible medium to facilitate communication of such software.

Throughout this specification, plural instances may implement components,

operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example implementations, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some implementations, a hardware component may be implemented mechanically, electronically, or any suitable combination thereof. For example, a hardware component may include dedicated circuitry or logic that is permanently configured to perform certain operations. For example, a hardware component may be a special-purpose processor, such as a field programmable gate array (FPGA) or an ASIC. A hardware component may also include programmable logic or circuitry that is temporarily configured by software to perform certain operations. For example, a hardware component may include software encompassed within a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where the hardware component comprises a general-purpose processor configured by software to become a special-purpose processor, the general-purpose processor may be configured as respectively different special-purpose processors (e.g., comprising different hardware components) at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, a processor being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented components may be located in a single geographic location (e.g., within a home environment, an office environment, or a server farm). In other example embodiments, the one or more processors or processor-implemented components may be distributed across a number of geographic locations.

### EXAMPLES

Example 1 is a method for adaptively tuning kswapd based on neural network functions trained by a server. The method comprises training, by a server using a neural network, a first function and a second function, the first function used to predict a reclaim size for reclaiming memory on a user device and the second function used to adjust a reclaim amount for the memory; in response to completion of the training, offloading weights of the first function and the second function to the user device, the weights causing an adjustment to the reclaim size and reclaim amount associated with kswapd at the user device; causing the user device to predict the reclaim size based on the first function; causing the user device to adjust the reclaim amount based on the second function; and causing the user device to reclaim memory based on the predicted reclaim size and adjusted reclaim amount when kswapd is woken.

In example 2, the subject matter of example 1 can optionally include wherein the neural network is a recurrent neural network.

In example 3, the subject matter of any of examples 1-2 can optionally include wherein the training or retraining comprises using backpropagation through time algorithm to train or retrain the first function and the second function.

In example 4, the subject matter of any of examples 1-3 can optionally include wherein the training or retraining further comprises detecting a number of direct reclaims triggered in a same workload; and tuning the first function and the second function to lower the number of direct reclaims.

In example 5, the subject matter of any of examples 1-4 can optionally include wherein causing the user device to adjust the reclaim amount comprises causing an adjustment to a high watermark for the memory.

In example 6, the subject matter of any of examples 1-5 can optionally include wherein causing the user device to predict the reclaim size based on the first function is based on a previous predicted reclaim size and a trend, the trend being based on current processes deployed on the user device.

In example 7, the subject matter of any of examples 1-6 can optionally include wherein causing the user device to adjust the reclaim amount based on the second function is based on a previous high watermark, a lower watermark, and a trend, the trend being based on current processes deployed on the user device.

In example 8, the subject matter of any of examples 1-7 can optionally include wherein the user device is an Android device.

In example 9, the subject matter of any of examples 1-8 can optionally include wherein the server comprises a cloud service that manages the user device.

In example 10, the subject matter of any of examples 1-9 can optionally include wherein offloading weights of the first function and the second function to the user device comprises downloading the weights to the user device via over-the-air updates.

Example 11 is a system for adaptively tuning kswapd based on neural network functions trained by a server. The system comprises one or more processors and a memory storing instructions that, when executed by the one or more processors, cause the one or more processors to perform operations comprising training, by a server using a neural network, a first function and a second function, the first function used to predict a reclaim size for reclaiming memory on a user device and the second function used to adjust a reclaim amount for the memory; in response to completion of the training, offloading weights of the first function and the second function to the user device, the weights causing an adjustment to the reclaim size and reclaim amount associated with kswapd at the user device; causing the user device to predict the reclaim size based on the first function; causing the user device to adjust the reclaim amount based on the second function; and causing the user device to reclaim memory based on the predicted reclaim size and adjusted reclaim amount when kswapd is woken.

In example 12, the subject matter of example 11 can optionally include wherein the neural network is a recurrent neural network.

In example 13, the subject matter of any of examples 11-13 can optionally include wherein the training or retraining comprises using backpropagation through time algorithm to train or retrain the first function and the second function.

In example 14, the subject matter of any of examples 11-13 can optionally include wherein the training or retraining further comprises detecting a number of direct reclaims triggered in a same workload; and tuning the first function and the second function to lower the number of direct reclaims.

In example 15, the subject matter of any of examples 11-14 can optionally include wherein causing the user device to adjust the reclaim amount comprises causing an adjustment to a high watermark for the memory.

In example 16, the subject matter of any of examples 11-15 can optionally include wherein causing the user device to predict the reclaim size based on the first function is based on a previous predicted reclaim size and a trend, the trend being based on current processes deployed on the user device.

In example 17, the subject matter of any of examples 11-16 can optionally include wherein causing the user device to adjust the reclaim amount based on the second function is based on a previous high watermark, lower watermark, and a trend, the trend being based on current processes deployed on the user device.

In example 18, the subject matter of any of examples 11-17 can optionally include wherein the user device is an Android device.

In example 19, the subject matter of any of examples 11-18 can optionally include wherein offloading weights of the first function and the second function to the user device comprises downloading the weights to the user device via over-the-air updates.

Example 20 is a storage medium comprising instructions which, when executed by one or more processors of a machine, cause the machine to perform operations for training and utilizing a spatial-temporal transformer to predict memory errors. The operations comprise training, by a server using a neural network, a first function and a second function, the first function used to predict a reclaim size for reclaiming memory on a user device and the second function used to adjust a reclaim amount for the memory; in response to completion of the training, offloading weights of the first function and the second function to the user device, the weights causing an adjustment to the reclaim size and reclaim amount associated with kswapd at the user device; causing the user device to predict the reclaim size based on the first function; causing the user device to adjust the reclaim amount based on the second function; and causing the user device to reclaim memory based on the predicted reclaim size and adjusted reclaim amount when kswapd is woken.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as

“processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific examples, various modifications and changes may be made to these examples without departing from the broader scope of examples of the present invention. For instance, various examples or features thereof may be mixed and matched or made optional by a person of ordinary skill in the art. Such examples of the present subject matter may be referred to herein, individually or collectively, by the term “invention” merely for convenience and without intending to voluntarily limit the scope of this application to any single invention or present concept if more than one is, in fact, disclosed.

The examples illustrated herein are believed to be described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various implementations of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly. to be regarded in an illustrative rather than a restrictive sense.

What is claimed is:

1. A method comprising:
training, by a server using a neural network, a first function and a second function, the first function used to predict a reclaim size for reclaiming memory on a user device and the second function used to adjust a reclaim amount for the memory;
in response to completion of the training, offloading weights of the first function and the second function to the user device, the weights causing an adjustment to the reclaim size and reclaim amount associated with kswapd at the user device;
causing the user device to predict the reclaim size based on the first function;
causing the user device to adjust the reclaim amount based on the second function; and
causing the user device to reclaim memory based on the predicted reclaim size and adjusted reclaim amount when kswapd is woken.

2. The method of claim 1, wherein the neural network is a recurrent neural network.

3. The method of claim 1, wherein the training or retraining comprises using backpropagation through time algorithm to train or retrain the first function and the second function.

4. The method of claim 3, wherein the training or retraining further comprises:
detecting a number of direct reclaims triggered in a same workload; and
tuning the first function and the second function to lower the number of direct reclaims.

5. The method of claim 1, wherein causing the user device to adjust the reclaim amount comprises causing an adjustment to a high watermark for the memory.

6. The method of claim 1, wherein causing the user device to predict the reclaim size based on the first function is based on a previous predicted reclaim size and a trend, the trend being based on current processes deployed on the user device.

7. The method of claim 1, wherein causing the user device to adjust the reclaim amount based on the second function is based on a previous high watermark, lower watermark, and a trend, the trend being based on current processes deployed on the user device.

8. The method of claim 1, wherein the user device is an Android device.

9. The method of claim 1, wherein the server comprises a cloud service that manages the user device.

10. The method of claim 1, wherein offloading weights of the first function and the second function to the user device comprises downloading the weights to the user device via over-the-air updates.

11. A system comprising,
one or more processors; and
a memory storing instructions that, when executed by the one or more processors, cause the one or more processors to perform operations comprising:
training, by a server using a neural network, a first function and a second function, the first function used to predict a reclaim size for reclaiming memory on a user device and the second function used to adjust a reclaim amount for the memory;
in response to completion of the training, offloading weights of the first function and the second function to the user device, the weights causing an adjustment to the reclaim size and reclaim amount associated with kswapd at the user device;
causing the user device to predict the reclaim size based on the first function;
causing the user device to adjust the reclaim amount based on the second function; and
causing the user device to reclaim memory based on the predicted reclaim size and adjusted reclaim amount when kswapd is woken.

12. The system of claim 11, wherein the neural network is a recurrent neural network.

13. The system of claim 11, wherein the training or retraining comprises using backpropagation through time algorithm to train or retrain the first function and the second function.

14. The system of claim 13, wherein the training or retraining further comprises:
detecting a number of direct reclaims triggered in a same workload; and
tuning the first function and the second function to lower the number of direct reclaims.

15. The system of claim 11, wherein causing the user device to adjust the reclaim amount comprises causing an adjustment to a high watermark for the memory.

16. The system of claim 11, wherein causing the user device to predict the reclaim size based on the first function is based on a previous predicted reclaim size and a trend, the trend being based on current processes deployed on the user device.

17. The system of claim 11, wherein causing the user device to adjust the reclaim amount based on the second function is based on a previous high watermark, lower watermark, and a trend, the trend being based on current processes deployed on the user device.

18. The system of claim 11, wherein user device is an Android device.

19. The system of claim 11, wherein offloading weights of the first function and the second function to the user device comprises downloading the weights to the user device via over-the-air updates.

20. A storage medium comprising instructions which, when executed by one or more processors of a machine, cause the machine to perform operations comprising:
training, by a server using a neural network, a first function and a second function, the first function used to predict a reclaim size for reclaiming memory on a user device and the second function used to adjust a reclaim amount for the memory;
in response to completion of the training, offloading weights of the first function and the second function to the user device, the weights causing an adjustment to the reclaim size and reclaim amount associated with kswapd at the user device;
causing the user device to predict the reclaim size based on the first function;
causing the user device to adjust the reclaim amount based on the second function; and
causing the user device to reclaim memory based on the predicted reclaim size and adjusted reclaim amount when kswapd is woken.
